(19) United States
(12) Patent Application Publication
(10) Pub. No.: US 2012/0117871 A1
(43) Pub. Date: May 17, 2012

(54) INTERLOCKING PLANTER AND PLANTER SYSTEM

(76) Inventor: Kelly William Luckett, Florissant, MO (US)

(21) Appl. No.: 13/296,992

(22) Filed: Nov. 15, 2011

Related U.S. Application Data
(60) Provisional application No. 61/413,774, filed on Nov. 15, 2010.

(51) Int. Cl. A01G 9/02

(52) U.S. Cl. 47/65.7; 47/83

(57) ABSTRACT

An adaptable terraced planter and system having a plurality of planters, each planter comprising a plastic body configured to retain soil with hinge brackets at each end that when interlocked with a pin or rod form a hinge there between to rotatably connect the planters together, and thereby enable the attachment of said at least one of the plurality of planters to another planter in more than one selective orientation and to allow for the stacking of rows of planters in vertical or tiered rows or variants thereof that conform to a wide variety of topographies.

### CROSS REFERENCE TO RELATED APPLICATIONS

This application is a continuation-in-part of U.S. Application No. 61/413,774, filed Nov. 15, 2010, for the invention of Kelly William Luckett entitled “Interlocking Planter and Planter System,” and derives and claims priority from that application, which Application No. 61/413,774 is fully incorporated by reference herein.

### STATEMENT REGARDING FEDERALLY SPONSORED RESEARCH OR DEVELOPMENT

Not applicable.

### BACKGROUND OF THE INVENTION

Retaining walls and terraced plantings are routinely used in many settings. Historically, such formations were constructed using natural materials such as rocks, lumber and earthen structures. Yet, these materials have their limitations, including availability, lack of uniformity and in some cases unacceptable durability. In recent years, precut stone and preformed concrete blocks, some being labeled as “faux stone”, have been widely used to build retaining walls and terraces. These “man-made” materials offer durability and relative ease in construction, while presenting a clean and uniform image. However, these materials also have shortcomings. Faux stone and stone retaining wall blocks are very heavy and can be broken, chipped and damaged from handling or during use. The weight of these traditional components adversely impacts shipping and delivery costs and logistics, and causes installation to be more taxing. Further, the structure of such faux stone and stone retaining wall blocks necessitates construction of retaining walls with only limited terraced orientation, and almost uniformly in which the blocks are themselves exposed as part of the appearance of the retaining wall. Additionally, stone components can be expensive, and replacement and repairs of stone and concrete retaining wall blocks can be difficult and costly.

It is therefore desirable to have retaining wall components that are lighter in weight, easier to install and more flexible in application, and which offers the option of creating a retaining wall of plants that has little, if any, other materials exposed. It would also be desirable for such components to be less expensive and easier to repair.

### BRIEF DESCRIPTION OF THE SEVERAL VIEWS OF THE DRAWINGS

The illustrative embodiments of the present invention are shown in the following drawings that form a part of the specification:

FIG. 1 is a perspective view of several of the interlocking planters of the present invention forming a terraced retaining wall;

FIG. 2 is a perspective view of a single planter of the present invention;

FIG. 3 is a perspective view of several of the interlocking planters of the present invention in the process of being formed into a terraced retaining wall;

FIG. 4 is another perspective view of several of the interlocking planters of the present invention in the process of being formed into a terraced retaining wall;

FIG. 5 is a cut-away side view of a three tiered terraced planter system of the present invention;

FIG. 6 is a perspective view of an alternate embodiment of a single planter of the present invention;

FIG. 7 is a top and side view of yet another alternate embodiment of a single planter of the present invention;

FIG. 8 is a plan view of several of the interlocking planters of the present invention in the process of formed into a curved two-tier terraced retaining wall.

Corresponding reference characters indicate corresponding parts throughout the several views of the drawings.

### DETAILED DESCRIPTION OF INVENTION

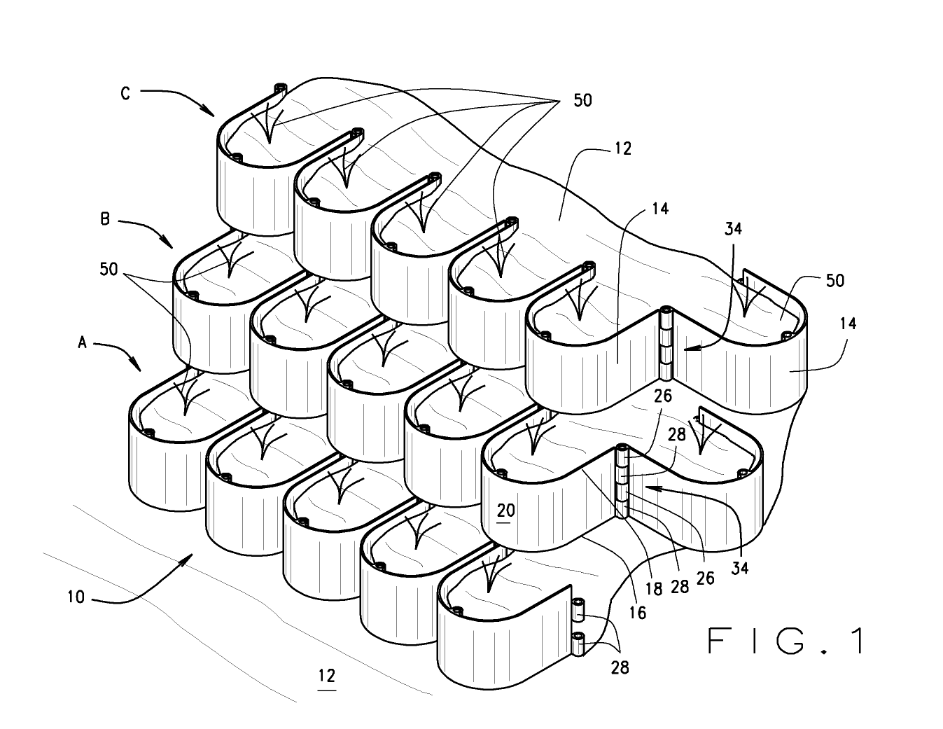

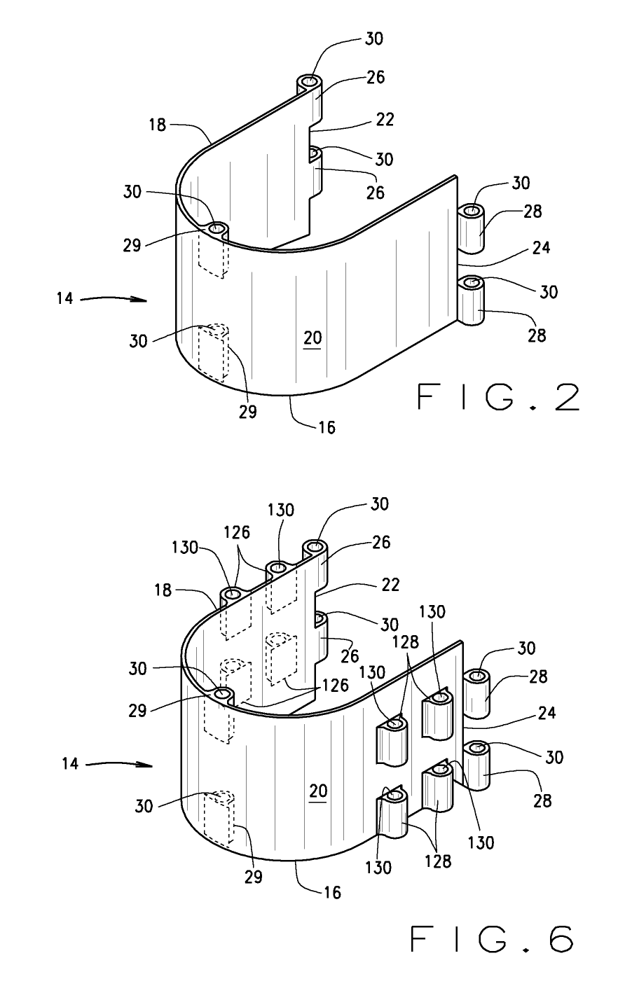

In an illustrative embodiment (FIG. 1), the interlocking planter system 10 is shown positioned on a sloping earthen surface 12. The surface 12 may be of virtually any profile, including for example, flat, pitched, curved or otherwise uneven. The system 10 comprises a plurality of substantially rigid interlocking planters 14. The planters 14 (FIG. 2) each have a generally horseshoe-shaped bottom edge 16 and a corresponding horseshoe-shaped top edge 18 with a conforming perpendicular sidewall 20 spanning between the bottom and top edges 16 and 18. The sidewall 20 terminates on one side of the planter 14 at a vertical first side edge 22 and terminates at the opposite side of the planter 14 at a vertical second side edge 24. The planters 14 are configured to retain soil, plants, or other growth media within the horseshoe-shaped sidewall 20.

For each planter 14, two vertically oriented coaxial hinge brackets 26 are positioned along the first side edge 22 and two corresponding vertically oriented coaxial hinge brackets 28 are positioned along the second side edge 24. The brackets 26 and 28 are configured, positioned and oriented to interlock with each other when the first side edge 22 of one planter 14 is positioned alongside a the second side edge of a second planter 14, together forming an integrated hinge. (FIG. 1). Two additional vertically oriented cylindrical brackets 29 are positioned at the apex and on the inside of the horseshoe-shaped curve along the top and bottom edges 16 and 18, midway between the first and second side edges 22 and 24. (FIG. 2).

A vertical through bore 30 is coaxially formed in the center of each of the brackets 26, 28 and 29 for each planter 14. Each of the bores 30 have the same diameter and the bores 30 of the brackets 26 and 28 are coaxially oriented along their respective edges 22 and 24, while the bores 30 of the brackets 29 are coaxial with one another. The bores 30 of the brackets 26 and 28 are further oriented and aligned along the edges 22 and 24 so as to receive a pin or rod 32 through the brackets 26 of one planter 14 and the brackets 28 of a second planter 14 when the brackets 26 and 28 are coaxially aligned. The brackets 26 and 28 each comprise a pair of individual brackets with the end of one of each pair of brackets coplanar with one of the bottom or top edges 16 and 18.

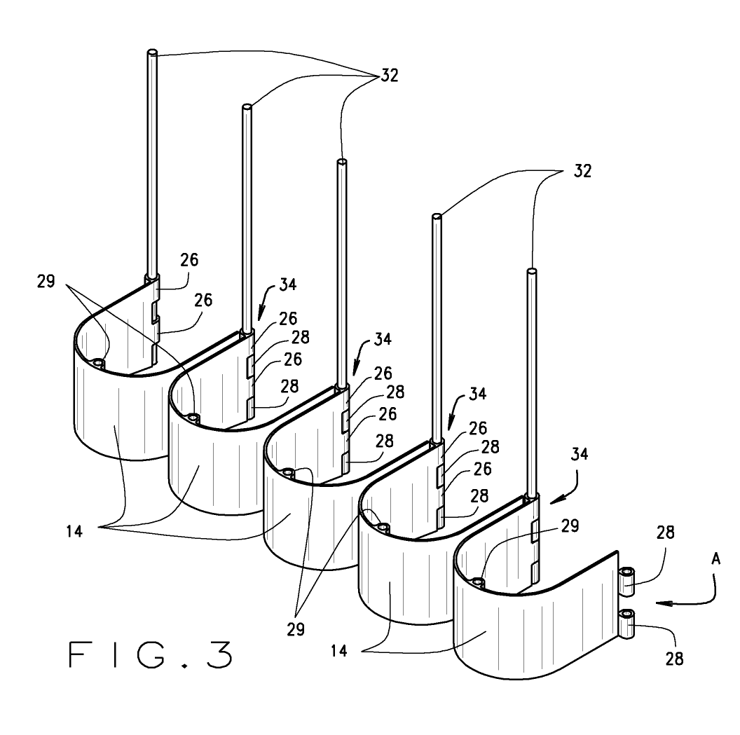

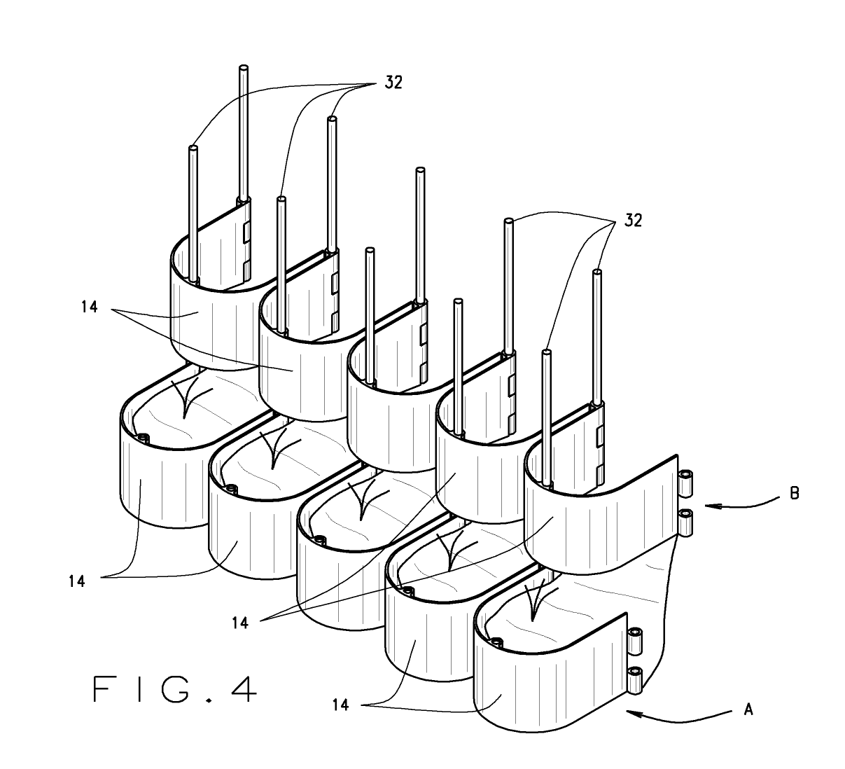

Referring to FIGS. 1 and 3, when a first planter 14 is positioned aside a second planter 14, such that the bores 30 in the brackets 26 of the first planter are coaxially aligned with and interlocking the brackets 28 of the second planter, and a rod 32 is placed through at least one of the bores 30 of each of the brackets 26 and 28, a pivotable side-mating hinge 34 is formed between the two side-mated planters 14. Further, and referring to FIG. 4, when a first planter 14 is positioned atop a second planter 14, such that the bores 30 in the brackets 26 or 28 of one of the upper planter 14 are coaxially aligned with the bores 30 in the brackets 29 for the lower planter 14, and a rod 32 is placed through at least one of the bores 30 of the brackets 26 or 28 and through at least one of the bores 30 of the brackets 29, a pivotable vertically-mating hinge 36 is formed between the two or more vertically-mated planters 14. Because the bores 30 are open along the top and bottom of each planter 14, the rod 32 can be placed through multiple vertically positioned rows of planters 14 to form a system 10 having multiple vertically oriented rows of planters 14, and the rods 32 can simultaneously be forced into the earthen surface 12 below the planter system 10 to secure the planter system 10 to the ground. (FIGS. 3-5). Of course, the side-mating hinge 34 may be formed from more brackets than the four brackets 26 and 28. That is, the planters 14 may alternatively be configured with multiple brackets of various sizes and shapes along the side edges 22 and 24, each having coaxial bores 30 such that when two planters 14 are positioned alongside each other and the bores 30 from each of the planters 14 are aligned with one another, the hinge 34 is created there between.

When a system 10 is being assembled, a plurality of metal rods 32 hold a plurality planters 14 together to form a retaining wall planter system 10. Typically, when assembling the system 10, the lowest level of planters 14 are first positioned in a first row A on the ground 12 (FIG. 3). Rods 32 are then placed through the bores 30 in the brackets 26, 28 and 29 of the first row A planters 14 and driven into the surface 12 to secure the first row A of planters 14 to the surface 12. (FIGS. 1, 3-5).

The rods 32 placed in the brackets 26 and 28 extend substantially above the top edges 18 of the planters 14 in the first row A to provide for the aligned and interlocking placement of additional rows B, C, etc. of planters 14 atop the first row A. In contrast, the rods 32 placed in the brackets 29 for the planters 14 of the first row A typically are shortened to preclude the rods 32 from extending above the top edges 18 of the planters 14. Soil or some other growth media is added to the row A planters 14 to at least partially fill the planters 14 in preparation for inserting plants into the planters 14.

A second row B of planters 14 is then positioned atop the first row A. Due to the novel design of the planters 14, the planters 14 comprising second row B can be oriented in a number of different configurations to enable a variety of desirable wall shapes, and for ease of adaptation to surfaces 12 having a multitude of differing topographies. For example, in a basic configuration, the planters 14 of the second row B are oriented such that the row B brackets 29 slide onto the rods 32 extending above the brackets 26 and 28 of the planters 14 for the first row A. This secures the row B planters in a uniform terraced orientation across the top of the row A planters. Additional rods 32 are then placed through the bores 30 in the brackets 26 and 28 of the second row B planters 14 and driven into the surface 12 to secure those row B planters 14 to the ground 12. As can be appreciated, this procedure can be repeated to add additional rows of planters 14 atop rows A and B. In addition, at any point in the construction of the planter system 10, each individual planter 14 can be rotated about the rods 32 at any of the brackets 26, 28 or 29, to shape the planter system 10 to conform to terrain topography. In such instances, it may be necessary to utilize additional rods 32 to independently secure one or more of the brackets 26, 28 or 29 to the surface 12. Further, the planters 14 can be added in a vertical orientation to form vertical walls, throughout the entire planter system 10 or at various locations in the system 10 as desired. Vegetation 50 can be placed in the planters 14 as desired.

Further due to the novel interlocking hinge design of the planters 14, the system 10 can be adapted at each level, A, B, C, etc, to match the shape and contours of virtually any topography at that level. That is, the first row A of planters 14 can be set side-by-side in a straight row as seen in FIG. 1, or any one of the planters 14 in a given row (i.e. A, B, C, etc.) can be pivoted about its hinge 34 holding it to the planter 14 next to it, to form a displacement in the row to match the contour of the surface 12 upon which the row is placed. For example, the rows A and B in FIG. 8 are depicted in curved orientation where the sidewalls 20 of the individual planters 14 are pivoted apart from each other about the rods 32 of the side-hinges 34.

As can be readily understood by one of ordinary skill in the art, the novel configuration of the planters 14 allows for the interlocking construction of planter systems 10 having a variety of configurations, including for example, vertical retaining walls with vertically oriented planters 14; vertical retaining walls with overlapping planters 14; terraced retaining walls with vertically oriented planters 14; terraced retaining walls with overlapping planters 14; and various combinations of these formations. Further, the hinges 34 and 36 formed between each set of the planters 14 allow for substantial flexibility in shaping the planter system 10 atop or along the surface 12.

In another embodiment of the present invention (FIG. 6), additional vertically oriented hinge brackets 126 and 128, each having vertically oriented and coaxial through bores 130, are positioned along the sidewall 20 at discrete positions incrementally spaced from respective edges 22 and 24. In this way, the brackets 26 can alternately and selectively be aligned and engaged with one of the sets of the additional brackets 126, and the bores 30 of the brackets 28 can alternatively and selectively be aligned and engaged with one of the sets of the additional brackets 128, such that the bores 30 align with the bores 130 in order to construct planter systems 10 with terraces having differing and predetermined slopes.

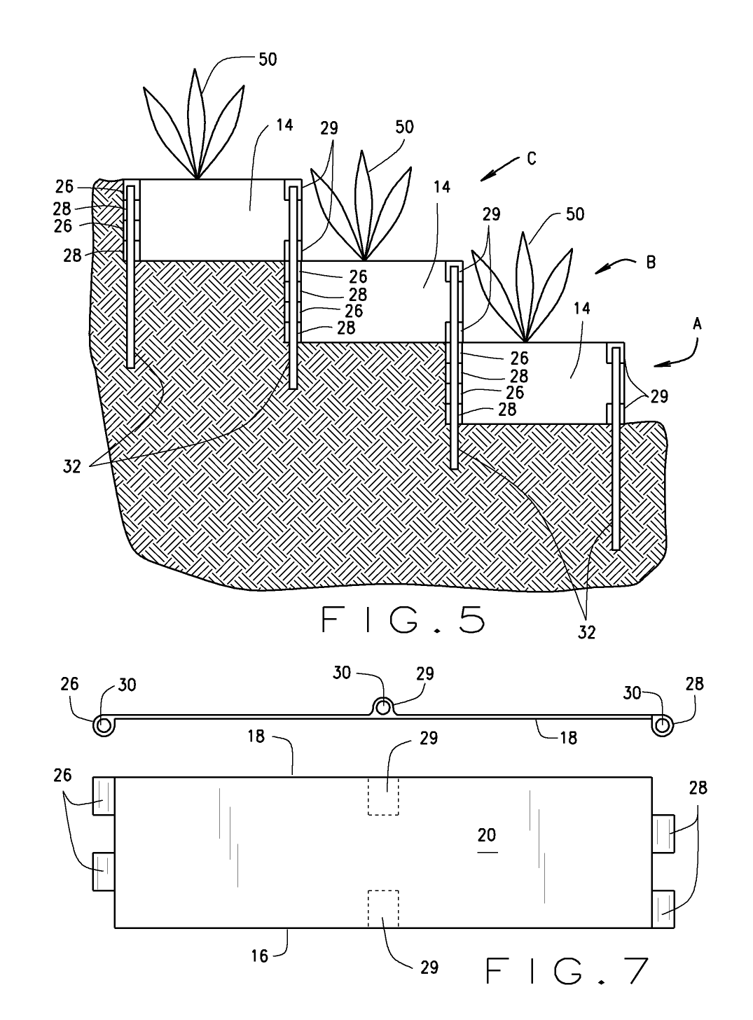

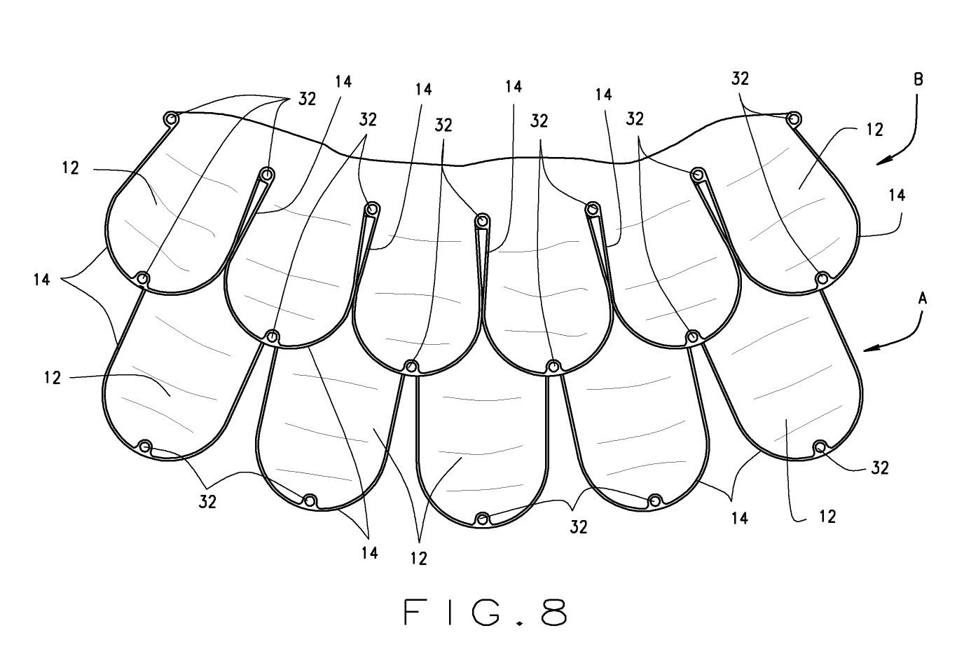

In yet another embodiment of the present disclosure (FIG. 7), the planters 14 are formed of a relatively firm, yet pliant material such as for example a partially pliant plastic. In particular, the properties of the material should be such that the planters 14 may lay flat, but can be readily curved along the edges 16 and 18 into a horseshoe shape, or other desirable shape, for placement in a planter system 10, while having sufficient rigidity between the edges 16 and 18 to provide a stable front face for the planter 14 to retain soil or growth media within the planter 14 without undue or unacceptable distortion. In this embodiment, the planters 14 can be produced in a flat orientation for ease of production, and can lay flat for each of shipping and storage. This embodiment also allows for more flexibility the shaping and formation of the exposed faces of the planters 14 in a planter system 10.

Alternatively, the planters 14 can be formed of a relatively rigid material, such as for example a rigid plastic, with vertical variations in thickness between the edges 16 and 18, to provide points of curvature along the edges 16 and 18. In another embodiment, vertical living hinges may be formed along the edges 16 and 18 to allow for flexibility in shaping the exposed face of the planter 14 when placed in a planter system 10.

In yet another embodiment of the present disclosure, flanges extend from the side edges 22 and 24 for penetration into the surface 12 when the planter 14 is positioned in a planter system 10, to additionally secure the planter system 10 to the surface 12. In yet another embodiment of the present disclosure, the planters 14 may be adapted to integrate with one another to provide an irrigation system for the planter system 10 that can water and feed the growth retained by the planters 14.

Preferably, the planters 14 are constructed of a green, substantially rigid plastic. However, variations on the material used to construct the planter 14 exist. For example, alternate colors or patterns of different colors may be used, combinations of pliant and/or flexible materials may be used to construct all or portions of the planters 14, and the material may be designed to allow for the flow of moisture through the planter wall, so long as the materials allow the planters to be used in accordance with the requirements as set forth in this disclosure.

Additional variations on the basic construction of the planter 14 and planter system 10 are also available. For example, the exact shape and size of the planter 14 can be varied to form larger or smaller configurations. The planter 14 may be thick or thin. The planter 14 may be formed in a variety of shapes in all three dimensions, taking for example the general shape of a box, a tube, or a cup, so long as the planter 14 retains its ability to perform as outlined in this disclosure. Likewise, the planters 14 may be of differing sizes in each of the three dimensions. The planter 14 may be constructed of a variety of materials, including but not limited to various plastics, rubbers, metals and fabrics, or any other suitable material that is capable of forming the planter system 10 and retaining growth media in the planters 14. Similarly, the rods 32 can be of a multitude of varying sizes and shapes, and may be constructed of a wide variety of materials, so long as the rods 32 are capable of performing as outlined in this disclosure.

Any number of two or more planters 14 may be interlocked together to form a planter system 10. Similarly, the number of planter rows, e.g., A, B, C, etc., in each planter system 10 can be any number greater than zero. Hence, the exact number of planters 14 and rows of planters 14 used in each embodiment of the planter system 10 may vary.

It is also contemplated that a system can be created using various sized planters 14 of the planter system 10 to enable the predetermination of the configuration and look of a planter system 10 prior to installation. That is, the slopes between each row of planters 14 depends upon the distance between the brackets 26 and 28 and the brackets 29, as well as the height of the planters 14. By varying these parameters, it is possible to create planters 14 that can be combined in varied configurations across a planter system 10 to create a planter system 10 with differing predetermined shapes and slopes. In addition, the widths and colors of the planters 14 can be varied. These planters 14 of varied shapes can be numbered in a categorized system to correspond to their differing dimensions. With this categorized system, a computer graphics program can be created that is capable of rendering a color graphic representation of a planter system 10 based upon the placement and configuration of each planter 14 used to form that particular planter system, as well as the particular vegetation that will be planted in each planter 14.

The detailed description above illustrates the invention by way of example and not by way of limitation. This description clearly enables one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

1. An interlocking planter system comprising:
a. a plurality of planters configured to selectively form a terraced or vertical wall when said planters are secured together, each planter being configured to retain growth media; and
b. a plurality of connectors, each connector configured to attach at least two of said plurality of planters together.

2. The planter system of claim 1, wherein at least one of said connectors is integral with one of said planters.

3. The planter system of claim 1, wherein at least one of said planters is configured to releasably interlock with at least one other of said planters.

4. The planter system of claim 1, wherein at least one of said planters is configured to rotatably interlock with at least one other of said planters.

5. The planter system of claim 1, wherein the planters are substantially rigid.

6. The planter system of claim 5, wherein at least one of the planters is generally horseshoe shaped with a top, a bottom and a back, and configured such that the top, the bottom and the back are all open.

7. The planter system of claim 1, wherein at least one of said connectors comprises a rod.

8. The planter system of claim 7, wherein the rod is configured to secure the planter system to the ground.

9. The planter system of claim 1, wherein the planters are configured to vertically orient in overlapping rows.

10. The planter system of claim 1, further comprising a rod and wherein the connector comprises a hinge, wherein each planter comprises a first hinge bracket and a second hinge bracket and the first hinge bracket of each planter is configured to mate with the second hinge bracket of any other planter and forms a hinge when the brackets are positioned together and the rod is inserted therein.

11. The planter system of claim 1, wherein at least one of the planters is substantially plastic.

12. The planter system of claim 11, wherein the planters are colored to substantially match the growth media retained by the planters.

13. An adaptable terraced planter system comprising:
a. a plurality of planters, each planter comprising a body configured to retain soil and comprising a plurality of brackets disposed on the body, each bracket configured to receive a connector; and
b. a plurality of connectors, each connector configured to mate alternatively with at least two of said plurality of brackets on at least one of said plurality of planters to thereby enable the attachment of said at least one of said plurality of planters to another planter in more than one selective orientation;
wherein the brackets for each planter are disposed along the planter body to provide multiple discrete positions for the attachment of each planter to another planter and thereby allow for multiple configurations in the shape and orientation of the terraced planter system.

14. The planter system of claim 13, wherein at least one of said plurality of planters is essentially plastic.

15. The planter system of claim 14, wherein the planters are colored to substantially match the growth media retained by the planters.

16. The planter system of claim 13, wherein the planters are generally horseshoe shaped with a top, a bottom and a back, and configured such that the top, the bottom and the back are all open.

17. The planter system of claim 13, further comprising a rod and wherein the connector comprises a hinge, wherein each planter comprises a first hinge bracket and a second hinge bracket and the first hinge bracket of each planter is configured to mate with the second hinge bracket of any other planter and forms a hinge when the brackets are positioned together and the rod is inserted therein.

18. An interlocking planter comprising a body having a first connector and a second connector, the first connector adapted to mate with the second connector of another interlocking planter, the planter being configured to retain growth media and to form a terrace or vertical wall when mated to another interlocking planter and placed against a slope.

19. The planter of claim 18, wherein the first connector comprises a first hinge bracket and the second connector comprises a second hinge bracket, wherein the first hinge bracket is configured to mate with the second hinge bracket of complementary planter to form a hinge there between when the brackets are positioned together and a rod is inserted therein.

20. The planter of claim 17, wherein mating the first connector of one planter with the second connector of a second planter forms a hinge between the two planters.
